(19) United States
(12) Patent Application Publication
(10) Pub. No.: US 2025/0303776 A1
(43) Pub. Date: Oct. 2, 2025

(54) CARD PERSONALIZATION RIBBON SECURITY

(71) Applicant: Entrust Corporation

(72) Inventors: SCOTT SVENSSON, Shakopee, MN (US); MATTHEW STEBBINS, Shakopee, MN (US)

(21) Appl. No.: 19/084,119

(22) Filed: Mar. 19, 2025

Related U.S. Application Data
(60) Provisional application No. 63/571,209, filed on Mar. 28, 2024.

(51) Int. Cl. B42D 25/41; B41J 2/325; B42D 25/23; B42D 25/455

(52) U.S. Cl. CPC B42D 25/41; B41J 2/325; B42D 25/23; B42D 25/455

(57) ABSTRACT

A security technique that helps prevent access to personal data left behind on ribbon supplies used in print stations of card or passport personalization systems. After printing, a section of the ribbon that bears the negative image of the personal data is wound onto a take-up roll and then fused to one or more additional layers of the ribbon wound onto the take-up roll. The fusing can be achieved using radiation, for example from a light source or from a source of thermal radiation, applied at least to the section of the ribbon bearing the negative image and also possibly applied to the additional layer(s). The fusing of the layers of the ribbon on the take-up roll prevents unwinding of the used ribbon to read the personal data in the negative images.

### RELATED APPLICATION

This application claims the benefit of U.S. Provisional Application No. 63/571,209, filed Mar. 28, 2024, the disclosure of which is incorporated herein by reference.

### FIELD

This technical disclosure relates to security techniques to prevent access to personal data left behind on ribbon supplies used in card personalization systems.

### BACKGROUND

When a print ribbon or other ribbon material is used in a card personalization system to print/produce personal data on a card, passport or other personalized document, certain personal data, such as names and account numbers, are left behind as a negative image on the used ribbon. For example, in the case of a print ribbon, a negative image is left behind on the portion of the used print ribbon where ink was transferred from the print ribbon to the card. The negative image, which can be an account number, the card holder name, a card verification value (CVV), and the like, creates a potential security concern since the data may be stolen from the used ribbon. Various techniques are known in the art for preventing access to personal data in used ribbons in card personalization systems. Examples includes the techniques described in U.S. Pat. Nos. 9,248,680; 10,744,806; and 11,613,132.

### SUMMARY

Security techniques are described that help prevent access to personal data left behind on ribbon supplies used in print stations of card personalization systems. The techniques described herein can also be used with print stations of passport personalization systems that personalize pages of passports such as the data page.

The security techniques can be used with any type of ribbon supply used in a card personalization system where material is transferred from the ribbon onto the card to create personal data thereby leaving behind a negative image on the ribbon where the material was transferred. Examples of ribbon supplies include, but are not limited to, a print ribbon, an indent ribbon, topping foil, or a retransfer ribbon. The transfer of the material onto the card may be referred to as printing. The printing on the card and the corresponding negative image left behind on the ribbon can be any type of personal data added to a card including, but not limited to, an account number, the card holder name, a card verification value (CVV), an image of the card holder, card holder address, and other personal data.

As described in further detail below, a section of the card personalization ribbon that bears the negative image of the personal data is wound onto a take-up roll and then fused to one or more additional layers of the ribbon wound onto the take-up roll. The fusing may be referred to as blocking the layers. In one embodiment, the fusing can be achieved using radiation, for example from a light source, or thermal radiation from a thermal radiation source, applied at least to the section of the ribbon bearing the negative image and also possibly applied to the additional layer(s). The fusing of the layers of the ribbon on the take-up roll prevents unwinding of the used ribbon to read the personal data in the negative images. If one attempts to unwind the used ribbon after fusing, the used ribbon will be destroyed making reading of the personal data in the negative images difficult if not impossible.

The fusing can occur at any point in time during or after use of the ribbon. In one embodiment, the fusing can occur once the ribbon is completely used and all of the used ribbon is wound onto the take-up roll. In this embodiment, the fusing process occurs once on the completely used ribbon. In another embodiment, the fusing can take place on the partially used ribbon as the ribbon is being used. In this embodiment, a plurality of fusing processes can take place at different points in time during use of the ribbon. In an embodiment, the fusing takes place in the print station in which the take-up roll is mounted without removing the take-up roll from the print station. In another embodiment, the fusing takes place outside of the print station by removing the take-up roll and then applying the radiation to the ribbon.

In one embodiment, a card personalization ribbon security method includes, in a print station of a card personalization system, using the card personalization ribbon supplied from a supply roll to print personal data on a surface of a card thereby creating a negative image of the personal data on a used section of the card personalization ribbon. Thereafter, the used section of the card personalization ribbon bearing the negative image of the personal data is wound onto a take-up roll. Within the print station, the used section of the card personalization ribbon bearing the negative image of the personal data is fused to another section of the card personalization ribbon on the take-up roll.

In another embodiment, a print station of a card personalization system includes a supply roll containing unused card personalization ribbon and a take-up roll that takes up the card personalization ribbon after use. A thermal print head is engageable with the card personalization ribbon to print personal data on a surface of a card thereby creating a negative image of the personal data on a used section of the card personalization ribbon. In addition, a fusing element is mounted adjacent to the take-up roll. The fusing element is positioned and configured to apply radiation to the used section of the card personalization ribbon while the used section is on the take-up roll. The applied radiation is sufficient to fuse the used section of the card personalization ribbon bearing the negative image of the personal data to another section of the card personalization ribbon on the take-up roll. In an embodiment, the applied radiation may be sufficient to fuse all of the layers of the used ribbon on the take-up roll, including the section bearing the negative image, to one another.

In another embodiment, a ribbon supply, such as a ribbon used in a card personalization system, can include a construction whereby a portion of the ribbon, such as back-coat thereof or a transferrable material thereof or both, includes an initiator and a polymerizable monomer(s). When exposed to light radiation, such as ultraviolet light, from a fusing element the initiator will cause the polymerizable monomer(s) to react and/or crosslink.

### DRAWINGS

FIG. 1 is a schematic depiction of a portion of a print station of a card personalization system that can implement the security method described herein.

FIG. 2 depicts a cross-section of a card personalization ribbon that can be used in the print station of FIG. 1.

FIG. 3 is a top view of the take-up roll of the FIG. 1 showing alternate positions of a fusing element relative to the take-up roll.

FIG. 4 illustrates an example of a card personalization system that can use the print station of FIG. 1.

FIG. 5 illustrates another example of a card personalization system that can use the print station of FIG. 1.

FIG. 6 illustrates a ribbon security method described herein.

### DETAILED DESCRIPTION

As used herein, the word “step” should be construed, unless otherwise indicated by Applicant, as including a single step or multiple sub-steps resulting in the step.

For convenience, the techniques described herein will be described with respect to a card personalization system. However, the concepts described herein can also be used in systems that personalize passports (passport personalization systems). The term “personalize” (or the like) as used throughout the specification and claims is intended to encompass operations performed on a card (or a page of a passport) that result in applying personal data of the intended card holder, or other data that is sensitive and which unauthorized access to is to be prevented, to the card by transferring material from a ribbon. An example of a personalization operation that personalizes the card is printing an account number, the card holder name, a card verification value (CVV), an image of the card holder, a card holder address, and other personal data on the card.

In an embodiment, the cards may be plastic cards or non-plastic cards. The cards (or personalized identification cards) described herein include, but are not limited to, financial (e.g., credit, debit, or the like) cards, access cards, driver's licenses, national identification cards, and business identification cards, and other identification cards. In an embodiment, the cards may be ID-1 cards as defined by ISO/IEC 7810. However, other card formats such as ID-2 as defined by ISO/IEC 7810 are possible as well. In the case of passports, the personal data can also be applied to pages, such as plastic pages, of passports as well. The passport pages can be a front cover or a rear cover of the passport, or an internal page (for example a page referred to as a data page) of the passport. In an embodiment, the passports may be in an ID-3 format as defined by ISO/IEC 7810.

The term “card” or “identification card”, unless indicated otherwise, refers to cards where the card substrate can be formed entirely of a material such as plastic, or formed of a combination of materials such as plastic and non-plastic materials. In one embodiment, the card can be sized to comply with ISO/IEC 7810 with dimensions of about 85.60 by about 53.98 millimeters (about 3 ⅜ in×about 2 ⅛ in) and rounded corners with a radius of about 2.88-3.48 mm (about ⅛ in). As would be understood by a person of ordinary skill in the art of identification cards, the cards are typically formed of multiple individual layers that form the majority of the card body or the card substrate. Similarly, the term “page” of a passport refers to passport pages where the passport can be formed entirely of a material such as plastic, or formed of a combination of materials such as plastic and non-plastic materials. An example of a passport page is the data page in a passport containing the personal data of the intended passport holder. The passport page may be a single layer or composed of multiple layers. In the case of a plastic card, examples of plastic materials that the card (or passport page), or the individual layers of the card or passport can be formed from include, but are not limited to, polycarbonate, polyvinyl chloride (PVC), polyester, acrylonitrile butadiene styrene (ABS), polyethylene terephthalate glycol (PETG), TESLIN®, combinations thereof, and other plastics.

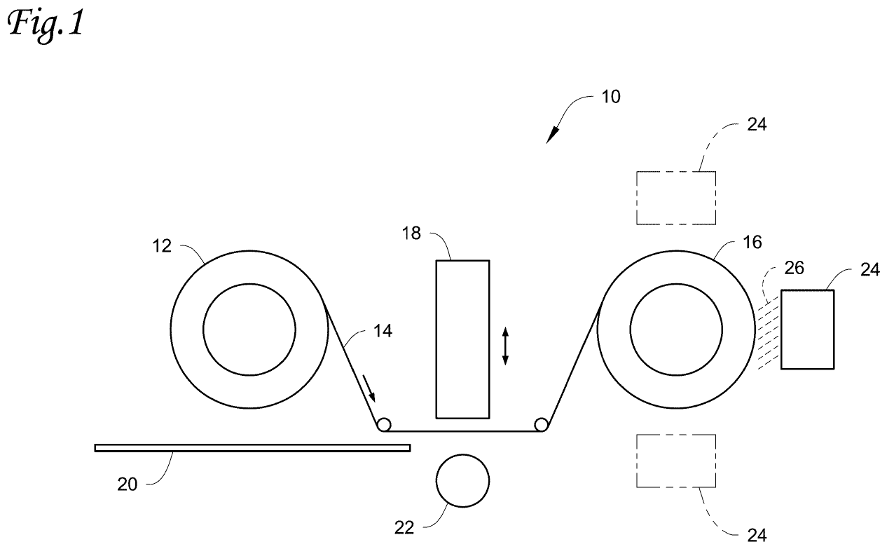

Referring now to FIG. 1, a portion of a print station 10 of a card personalization system is illustrated. The print station 10 includes a supply roll 12 that supplies unused card personalization ribbon 14, and a take-up roll 16 that takes-up used ribbon. The ribbon 14 is directed past a thermal print head 18 which causes the transfer of transferrable material from the ribbon 14 onto a surface of a card 20. A backing roller 22 is disposed opposite the print head 18 and supports the card 20 during printing. As indicated by the arrow, the print head 18 may be movable toward and away from the backing roller 22 which may be fixed. Alternatively, the print head 18 may be fixed and the backing roller 22 may be movable toward and away from the print head 18.

As described in U.S. Pat. Nos. 9,248,680; 10,744,806; and 11,613,132, when printing personal data on the card 20, the transfer of the transferrable material from the ribbon 14 onto the card surface creates a negative image of the personal data on the ribbon 14. Unauthorized access to the negative images in the ribbon is a security risk and efforts are implemented to control access to the used ribbon. U.S. Pat. Nos. 9,248,680; 10,744,806; and 11,613,132 are incorporated herein by reference in their entirety.

Returning to FIG. 1, at least one fusing element 24 is mounted adjacent to the take-up roll 16. The fusing element 24 is configured to cause one or more layers of the used ribbon 14 wound on the take-up roll 16 to fuse together on the take-up roll 16. For example, the fusing element 24 is positioned and configured to apply radiation 26 to one or more layers of the used ribbon 14, including to the used section of the ribbon 14 that bears or contains the negative image of the personal data. The radiation that is applied is sufficient to fuse the used section of the ribbon 14 bearing the negative image of the personal data to another section of the ribbon 14 on the take-up roll 16. In the illustrated example, the fusing takes place in the print station 10 with the take-up roll 16 mounted in position (i.e. without removing the take-up roll 16 from the print station 10).

In one embodiment, the fusing element 24 can be one or more light sources that can emit suitable radiation for achieving fusing. For example, the one or more light sources can emit high intensity visible light or UV radiation. The one or more light sources may be one or more light emitting diodes. The use of radiation from a light source is suitable when the ribbon 14 includes an initiator and polymerizable monomer(s), where the initiator is activated by the radiation emitted by the light source to cause the polymerizable monomer(s) to react and/or crosslink, and thereby cause one or more layers of the used ribbon 14, including the used section of the ribbon 14 that bears or contains the negative image of the personal data, to fuse together.

In another embodiment, the radiation can be thermal radiation and the fusing element 24 can be one or more heating sources that generate heat that is directed onto the ribbon 14. The heat is sufficient to create a temperature-induced change in the ribbon 14 and thereby cause one or more layers of the used ribbon 14, including the used section of the ribbon 14 that bears or contains the negative image of the personal data, to fuse together.

FIG. 1 depicts an example location of the fusing element 24 as being on the far side of the take-up roll 16 furthest from the supply roll 12. This position of the fusing element 24 places the thermal print head 18 and the take-up roll 16 between the supply roll 12 and the fusing element 24, and reduces the chance that radiation from the fusing element 24 will reach unused portions of the ribbon 14 on the supply roll 12 or between the supply roll 12 and the thermal print head 18. FIG. 1 also depicts possible alternative locations of the fusing element 24 (in broken lines) above the take-up roll 16 and directing radiation downward onto the ribbon 14 on the take-up roll 16, or below the take-up roll 16 and directing radiation upward onto the ribbon 14 on the take-up roll 16. FIG. 3 illustrates additional possible locations of the fusing element(s) 24. For example, fusing elements 24 (in broken lines) can be located at the ends of the take-up roll 16 and direct radiation onto the ends of the ribbon 14 on the take-up roll 16. In an embodiment, two or more of the fusing elements 24 can be used, for example at any two or more of the locations indicated in FIGS. 1 and 3.

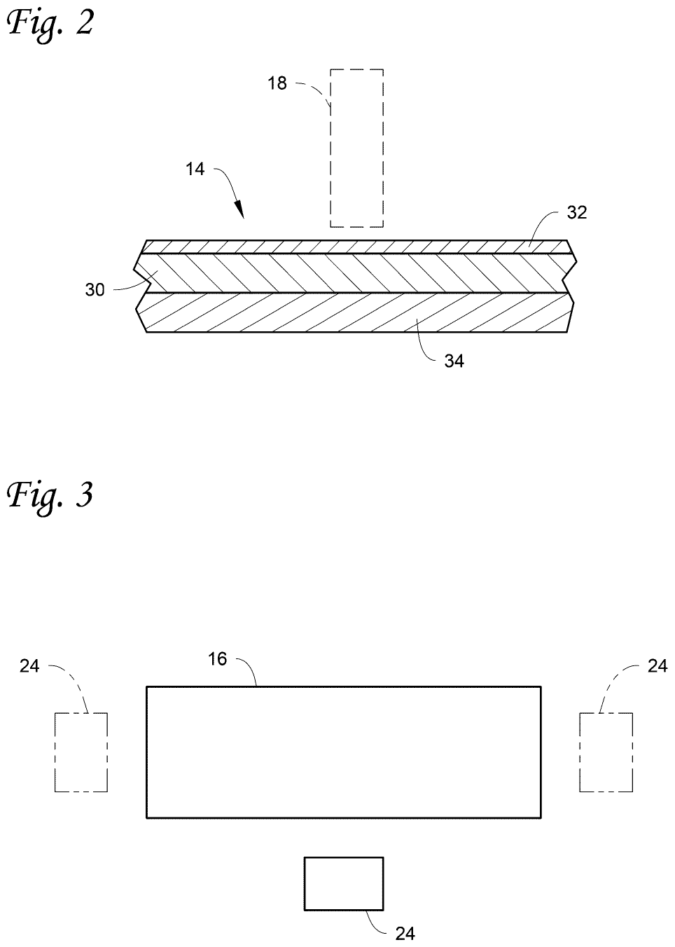

Referring to FIG. 2, a cross-sectional view of an example of the ribbon 14 is depicted. In this example, the ribbon 14 includes a substrate 30, a back-coat 32 disposed on one surface of the substrate 30, and a transferrable material 34 disposed on the opposite surface of the substrate 30. The substrate 30 acts as a support for both the back-coat 32 and the transferrable material 34. The back-coat 32 is configured to prevent the ribbon 14 from sticking to itself when the ribbon 14 is wound onto itself into a roll. Portions of the transferrable material 34 are configured to be transferred by heat that is applied by the thermal print head 18 (depicted in broken lines) to the surface of the card. The transferrable material 34 can be a pigment, a dye, a wear material, or other thermally transferrable material used in card personalization ribbons. In the case of fusing resulting from radiation emitted from a light source as described above, an initiator and a polymerizable monomer(s) can be added to the back-coat 32, to the transferrable material 34, or to both the back-coat 32 and the transferrable material 34. When portions of the used ribbon 14 are contacted by light radiation from the fusing clement 24, the initiator will cause the polymerizable monomer(s) to react and/or crosslink and thereby cause layers of the used ribbon 14 on the take-up roll 16, including the section of the used ribbon bearing the negative image of the personal data, to fuse together.

In the case of fusing of the ribbon 14 using one or more light sources, the ribbon 14 or portions thereof can be formed of or include any material(s) suitable for achieving the fusing resulting from light exposure described herein. For example, in the case of fusing using UV light, curing can be achieved using UV radical or UV cationic curing, each of which can include an initiator and a polymerizable monomer.

The ribbon 14 or portions thereof can be provided with one or more photoradical initiators and/or one or more photocationic initiators. Photoradical initiators generate free radicals by irradiation with light. In the case of UV light, examples of UV radical photopolymerization initiators include, but are not limited to, diethoxyacetophenone, 2-hydroxy-2-methyl-1-phenylpropan-1-one, benzyldimethyl ketal, 4-(2-hydroxyethoxy) phenyl-(2-hydroxy-2-propyl) ketone, 1-hydroxycyclohexyl phenylketone, 2-methyl-2-morpholino (4-thiomethylphenyl) propan-1-one, 2-benzyl-2-dimethylamino-1-(4-morpholinophenyl) butanone, 2-hydroxy-2-methyl-1 acetophenones, isopropylthioxanthone, 4-isopropylthioxanthone, 2,4-diethylthioxanthone, 2,4-dichlorothioxanthone and 1-chloro-4-propoxythioxanthone. In an embodiment, acetophenones, benzophenones, and acyl phosphine oxides can be used.

Radically polymerizable monomers have ethylenically unsaturated bonds capable of addition polymerization. Examples of addition-polymerizable ethylenically-unsaturated monomers include, but are not limited to, acrylic acid, methacrylic acid, maleic acid, and esters of aliphatic polyhydric alcohol monomers and unsaturated carboxylic acids. Specific examples of an ester of an aliphatic polyhydric alcohol monomer and an unsaturated carboxylic acid include, but are not limited to, acrylic acid esters such as ethylene glycol diacrylate, triethylene glycol diacrylate, 1,3-butanediol diacrylate, and tetramethylene glycol diacrylate, propylene glycol diacrylate, neopentyl glycol diacrylate, trimethylolpropane triacrylate, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate and dipentaerythritol hexaacrylate.

Photocationic initiators generate cations by irradiation with light. UV cationic photopolymerization initiators are onium salts such as, but not limited to, diazonium salt, ammonium salt, phosphonium salt, iodonium salt, sulfonium salt, selenonium salt and arsonium salt. The following compounds are examples of photocationic initiators that can be used: arylsulfonium salts such as triphenylsulfonium hexafluorophosphate and triphenylsulfonium hexafluoroantimonate.

Cationic polymerizable monomers undergo addition polymerization via acid-generated radicals. Examples of cationically polymerizable monomers include, but are not limited to, epoxy compounds, vinyl ether compounds and oxetane compounds. Examples of epoxy compounds include, but are not limited to, aromatic epoxides, alicyclic epoxides, and aliphatic epoxides. In one embodiment, aromatic epoxides and alicyclic epoxides can be used. Examples of vinyl ether compounds include, but are not limited to, ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether and cyclohexanedimethanol divinyl ether. In an embodiment, oxetane compounds with 1 to 4 oxetane rings in the structure can be used.

Returning to FIG. 1, the fusing described herein can occur as the used section of the ribbon 14 bearing the negative image of the personal data is moving relative to the fusing element 24. For example, as used ribbon 14 including the used section bearing the negative image is being wound onto the take-up roll 16, the fusing element 24 can apply the radiation to the used section bearing the negative image as well as apply radiation to adjacent portions of the ribbon. In another embodiment, the used section of the ribbon 14 bearing the negative image of the personal data may be stationary while the radiation is applied thereto by the fusing element 24.

The fusing described herein can occur at any point in time during or after use of the ribbon 14. For example, in one embodiment, the fusing can occur once the ribbon 14 is completely used and all of the used ribbon 14 is wound onto the take-up roll 16 and the ribbon 14 is no longer attached to the supply roll 12. In this embodiment, the fusing process occurs a single time on the completely used ribbon 14.

In another embodiment, the fusing can take place on the partially used ribbon 14 as the ribbon 14 is being used and the ribbon 14, including possibly some unused portions of the ribbon 14, is still attached to the supply roll 12. In this embodiment, a plurality of fusing processes by the fusing element 24 can take place at different points in time during use of the ribbon 14. In addition, after one fusing process, an additional length of the ribbon 14 is wound onto the take-up roll 16 followed thereafter by another fusing process by the fusing element 24. For example, after printing personal data on a first card and the used section of ribbon bearing the negative image of that personal data is fused, the ribbon 14 is used to print personal data on a surface of a second card thereby creating a negative image of the personal data on a second used section of the ribbon 14. Thereafter, the second used section of the ribbon 14 bearing the negative image of the personal data is wound onto the take-up roll 16, and the second used section of the ribbon 14 bearing the negative image of the personal data is fused to another section of the ribbon 14 on the take-up roll 16. This process of printing and creating the negative image, followed by winding onto the take-up roll and fusing the used section of the ribbon to the used ribbon, can be repeated a number of times over the length of the ribbon 14. In another embodiment, periodic fusing can be implemented. For example, the print station 10 can be controlled so that fusing occurs after a predetermined number of cards are printed on, or after a predetermined period of time, or after a predetermined number of wraps of the ribbon around the take-up roll 16. In an embodiment, fusing can occur every other revolution of the take-up roll.

During fusing, the used section of the ribbon 14 bearing the negative image of the personal data may overlay and be fused to an underlying section of the ribbon 14 on the take-up roll 16. The used section of the ribbon 14 bearing the negative image of the personal data may also underlie and be fused to an overlying section of the ribbon 14 on the take-up roll 16. The used section of the ribbon 14 bearing the negative image may be fused to two or more underlying layers of the ribbon 14 and/or fused to two or more overlying layers of the ribbon 14.

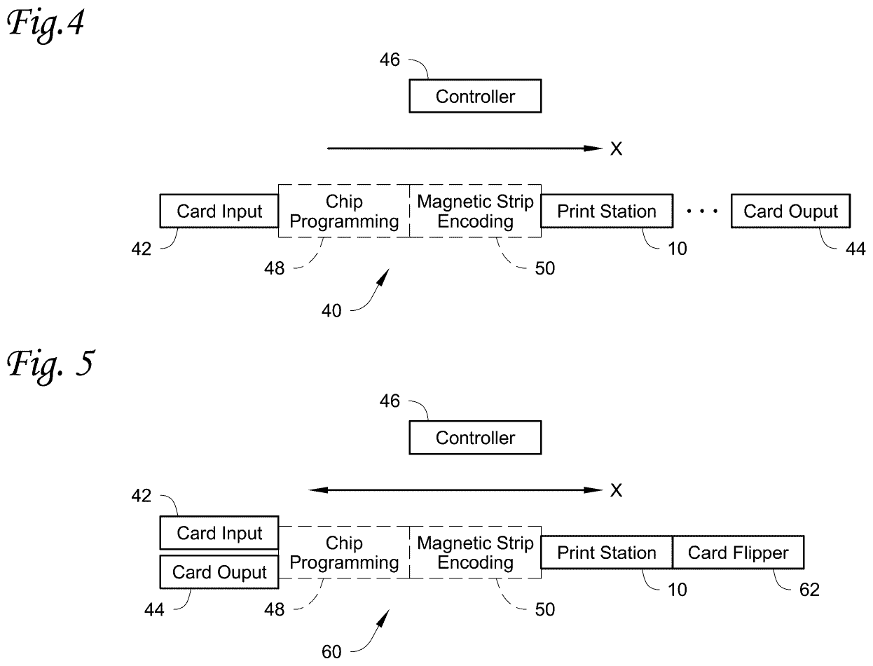

FIG. 4 schematically depicts an example of a card personalization system 40 that can include the print station 10 described herein. In this example, the components of the system 40 are depicted as being arranged as a large volume batch production card processing system with a card input 42 and a card output 44 at opposite ends, the print station 10 arranged between the input 40 and the output 44, and the cards transported by suitable transport mechanisms along a generally linear card transport path X. The cards can be transported in a forward direction (i.e. in a direction toward the output 44) along the transport path X and optionally in a reverse direction (toward the input 42). In this example, the print station 10 is between the input 42 and the output 44.

The card input 42 can be configured to hold a plurality of cards (or passports) waiting to be processed and that mechanically feeds the cards one by one into the card transport path X of the system 40 using a suitable card feeder known in the art. In one embodiment, the card input 42 can be an input hopper. In another embodiment, the card input 42 can be an input slot through which individual card are manually or automatically fed for processing. The card output 44 can be configured to hold a plurality of cards after they have been processed in the system 40. In this configuration, the card output 44 is often termed a card output hopper. The construction and operation of output hoppers is well known in the art. In another embodiment, the card output 44 can be an output slot.

The system 40 further includes a controller 46 that controls operation of the card input 42, the card output 44, the print station 10 and other components (if any) of the system 40, the transport of the card(s) within the system 40, etc. The controller 46 is any arrangement of hardware and/or software that controls operation of the system 40 including the components 10, 42, and 44.

With continued reference to FIG. 4, the system 40 can optionally include additional components. For example, the system 40 may optionally include a chip testing/programmer 48 and/or a magnetic strip encoder 50. The chip testing/programmer 48 is configured to perform contact or contactless testing of an integrated circuit chip on each card to test the functionality of the chip, as well as program the chip. Testing the functionality of the chip can include reading data from and/or writing data to the chip. In one embodiment, the chip testing/programmer 48 can be configured to simultaneously program the chips on a plurality of cards. The construction and operation of chip testing/programmers in card processing systems is well known in the art. The magnetic strip read/write encoder 50 is configured to read data from and/or encode data on a magnetic strip on each card (if the cards include a magnetic strip). The construction and operation of magnetic strip read/write testing devices in card processing systems is well known in the art.

The system 40 in FIG. 4 may also include optional other card processing mechanism(s). Any additional mechanism(s) may be located between the print station 10 and the chip programmer 48, and/or located between the print station 10 and the output 44, and/or located at other positions. The additional mechanism(s) can be card processing mechanisms known in the art to perform card processing operations that are known in the art. For example, the additional card processing mechanism(s) can be configured to perform one or more of embossing; indenting; laminating; laser marking using a laser; apply a topcoat; a quality control station that is configured to check the quality of personalization/processing applied to the card(s); a radiation curing station to apply radiation to cure radiation curable ink; a security station that is configured to apply a security feature such as a holographic foil patch to the card(s); and other card processing operations.

FIG. 5 schematically depicts another example of a card personalization system 60 that can include the print station 10 described herein. In this example, the components of the system 60 are depicted as being arranged as a desktop card personalization system that is typically designed for relatively smaller scale, individual card personalization in relatively small volumes, for example measured in tens or low hundreds per hour (often termed desktop processing machines). In FIG. 5, elements that are the same or similar in function to elements in FIG. 4 are referenced using the same reference numerals.

The system 60 includes the card input 42 and the card output 44 at the same end, although the card input 42 and the card output 44 can have other relative positions known in desktop card personalization machines. The print station 10 is arranged downstream of the input 40 and the output 44, and the cards transported by suitable transport mechanisms along a generally linear card transport path X in both a forward direction (i.e. in a direction toward the print station 10) along the transport path X and in a reverse direction (toward the output 44). The system 60 further includes the chip testing/programmer 48 and/or the magnetic strip encoder 50. If two-sided or duplex printing is desired, the system 60 can also include a card flipper 62 which is configured to flip a card 180 degrees so that the previously downward facing surface is now facing up and the card can be transported back into the print station 10 for printing on the now upward facing surface.

The cards can be transported through the print station and the card personalization systems using any suitable mechanical card transport mechanism(s) that are well known in the art. Examples of card transport mechanisms that could be used are known in the art and include, but are not limited to, transport rollers, transport belts (with tabs and/or without tabs), vacuum transport mechanisms, transport carriages, and the like and combinations thereof. Card transport mechanisms are well known in the art. A person of ordinary skill in the art would readily understand the type(s) of card transport mechanisms that could be used, as well as the construction and operation of such card transport mechanisms.

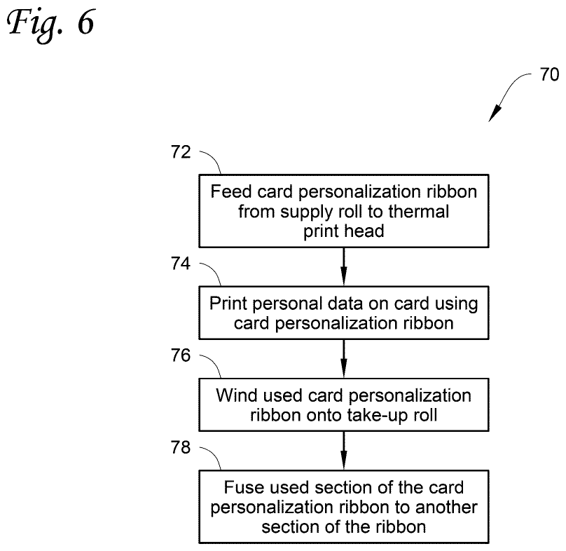

Referring now to FIG. 6 together with FIG. 1, a ribbon security method 70 is depicted. In the method 70, in step 72 the card personalization ribbon 14 is fed from the supply roll 12 to the thermal print head 18 to position a new, fresh or unused section of the print ribbon 14 under the print head 18 ready for printing on the card 20. Simultaneously therewith (or shortly before or shortly after), the card 20 is transported into position under the print head 18. Once the ribbon 14 and the card 20 are in position, in step 74 personal data is printed on the card 20 by transferring transferrable material from the ribbon 14 using the print head 18 as the ribbon 14 and the card 20 are transported together underneath the print head 18. The printing of the personal data creates a negative image of the personal data on the ribbon 14.

After printing on the card surface is complete, at step 76 the used ribbon 14 bearing the negative image is wound onto the take-up roll 16. The winding in step 76 could occur immediately prior to printing on any additional cards, or the winding in step 76 could occur after one or more additional cards are printed and the used section of the ribbon ultimately reaches the take-up roll 16. Once the used section of the ribbon is on the take-up roll 16, at step 78 the used section of the ribbon 14 is fused to another section of the ribbon 14. As explained above, the fusing takes place by activating the fusing element 24 and directing radiation from the fusing element 24 onto the ribbon on the take-up roll including onto the used section of the ribbon 14. As explained above, the fusing in step 78 can take place after the entire ribbon 14 has been used and is completely wound onto the take-up roll 16, or the fusing can take place on partially used ribbon 14 with the ribbon 14 still connected to the supply roll 12 with sections of the ribbon 14 still to be used. Sometime after step 78 is completed, another used section of the ribbon that results from printing on another card may be fused to another section of ribbon. Alternatively, if the entire ribbon is used at step 78, the now fused take-up roll can be removed and disposed of.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A card personalization ribbon security method comprising:
in a print station of a card personalization system, using the card personalization ribbon supplied from a supply roll to print first personal data on a surface of a first card thereby creating a negative image of the first personal data on a first used section of the card personalization ribbon;
thereafter winding the first used section of the card personalization ribbon bearing the negative image of the first personal data onto a take-up roll;
within the print station, fusing the first used section of the card personalization ribbon bearing the negative image of the first personal data to another section of the card personalization ribbon on the take-up roll.

2. The card personalization ribbon security method of claim 1, wherein the fusing comprises applying radiation to the first used section of the card personalization ribbon bearing the negative image of the first personal data.

3. The card personalization ribbon security method of claim 2, wherein the radiation is applied from a light source.

4. The card personalization ribbon security method of claim 2, wherein the radiation comprises thermal radiation.

5. The card personalization ribbon security method of claim 2, wherein the fusing occurs as the first used section of the card personalization ribbon bearing the negative image of the first personal data is moving relative to a source of the radiation.

6. The card personalization ribbon security method of claim 1, wherein the fusing occurs while the card personalization ribbon is connected to the supply roll.

7. The card personalization ribbon security method of claim 1, wherein after the fusing, winding an additional length of the card personalization ribbon onto the take-up roll.

8. The card personalization ribbon security method of claim 1, wherein the fusing occurs periodically.

9. The card personalization ribbon security method of claim 1, wherein the first used section of the card personalization ribbon bearing the negative image of the first personal data overlays the another section of the card personalization ribbon on the take-up roll.

10. The card personalization ribbon security method of claim 1, wherein the first used section of the card personalization ribbon bearing the negative image of the first personal data underlies the another section of the card personalization ribbon on the take-up roll.

11. The card personalization ribbon security method of claim 1, wherein after the fusing:
using the card personalization ribbon to print second personal data on a surface of a second card thereby creating a negative image of the second personal data on a second used section of the card personalization ribbon;
thereafter winding the second used section of the card personalization ribbon bearing the negative image of the second personal data onto the take-up roll;
within the print station, fusing the second used section of the card personalization ribbon bearing the negative image of the second personal data to another section of the card personalization ribbon on the take-up roll.

12. The card personalization ribbon security method of claim 1, wherein the card personalization ribbon comprises a print ribbon, an indent ribbon, topping foil, or a retransfer ribbon.

13. The card personalization ribbon security method of claim 1, wherein the card personalization ribbon includes an initiator and a polymerizable monomer.

14. A print station of a card personalization system, the print station comprising:
a supply roll containing unused card personalization ribbon;
a take-up roll that takes up the card personalization ribbon after use;
a thermal print head that is engageable with the card personalization ribbon to print personal data on a surface of a card thereby creating a negative image of the personal data on a used section of the card personalization ribbon;
a fusing element mounted adjacent to the take-up roll, the fusing element is positioned and configured to apply radiation to the used section of the card personalization ribbon while the used section is on the take-up roll that is sufficient to fuse the used section of the card personalization ribbon bearing the negative image of the personal data to another section of the card personalization ribbon on the take-up roll.

15. The print station of claim 14, wherein the fusing element comprises at least one light source.

16. The print station of claim 14, wherein the fusing element comprises a source of thermal radiation.

17. The print station of claim 14, wherein the fusing element is positioned so that the thermal print head and the take-up roll are positioned between the supply roll and the fusing element.

18. The print station of claim 14, wherein the card personalization ribbon comprises a print ribbon, an indent ribbon, topping foil, or a retransfer ribbon.

19. The print station of claim 14, wherein the card personalization ribbon includes an initiator and a polymerizable monomer.
